(19) United States
(12) Patent Application Publication
(10) Pub. No.: US 2023/0185963 A1
(43) Pub. Date: Jun. 15, 2023

(54) SYSTEM AND METHOD FOR MANAGEMENT OF ACCESS TO CUSTOMER DATA

(71) Applicant: VRMDB SERVICES PRIVATE LIMITED, Mumbai (IN)

(72) Inventors: Maulik Bipin Bagadia, Mumbai (IN); Rajeev Kashinath Jha, Mumbai (IN)

(73) Assignee: VRMDB SERVICES PRIVATE LIMITED, Mumbai (IN)

(21) Appl. No.: 17/923,868

(22) PCT Filed: Apr. 6, 2021
(86) PCT No.: PCT/IN2021/050339

§ 371 Date: Nov. 7, 2022

(30) Foreign Application Priority Data
May 9, 2020 (IN) 202021019675

(51) Int. Cl. G06F 21/62; G06F 21/64

(52) U.S. Cl. CPC G06F 21/6254; G06F 21/64

(57) ABSTRACT

A system and method for management of access to customer data is provided. The system includes a communication device of the customer and an application server. The communication device receives credentials of the customer. The application server generates a communication link with the communication device and a profile of the customer is created at a storage unit and a unique anonymous ID is appended to the same. In the event a future service provider requests for access to customer data, the credentials are appended to the profile at the application server received from the communication device for a pre-determined time period and a secure channel is generated between the future service provider communication device and the application server to allow the future service provider to access the customer data. The secure channel is terminated and the appended credentials to the profile are erased, thereby maintaining anonymity of the customer.

### FIELD OF THE INVENTION

The present invention relates to management of access to customer data, and more particularly relates to system and method for management of access to customer data.

### BACKGROUND OF THE INVENTION

In the present age, it is imperative to maintain confidentiality of data. Since the world is changing from a paper-based documentation system to a paperless documentation system, it is the need of the hour to ensure that the data stored in storage means such as, but not limited to, servers and other allied devices are confidential. In the event of a breach of confidential data of the owner, a repel effect can be created which could harm the owner to a great extent.

Sectors such as, but not limited to, medical, banking, information technology, government, etc. have a requirement to maintain confidentiality of records to the highest level so that in any event, breach of confidentiality of data does not occur. Further, these sectors have records of thousands of owners stored in the storage means such as, servers and other allied devices. In the event the records in these storage means are hacked, all the confidential data would be exposed and thereby resulting in issues, such as, misuse of data and other issues.

Further, once the confidential data is uploaded and/or received in these storage means, the internal processes should be robust to ensure that the data is arranged in a systematic manner or else, retrieving the data will be difficult and time consuming. In addition, it can also lead to errors which could be time consuming to rectify.

Further, now days there are a lot of applications which can automatically access the data even without the consent or knowledge of the owner. During these instances, the confidential data may be compromised. Further, in situations when the owner of the confidential data intends to have the confidential data being erased from a particular storage means, the agency maintaining the storage means can misuse the confidential data without the knowledge of the owner.

In view of the above, there is a dire need for systems and methods for management of access to customer data, thereby ensuring confidentiality is not compromised.

### SUMMARY OF THE INVENTION

One or more embodiments of the present invention, provides system and method for management of customer data.

In one aspect of the invention, a system for management of access to customer data is provided. The system comprises a communication device having an installable interface module operable on a processor, configured to receive credentials of a customer. An application server including a communication transceiver, one or more processors coupled to a memory having instructions, the processor is configured to establish a communication link with the communication device in response to installation of the customer interface module by the customer. Further, receive a unique identifier and a customer identifier of the customer from the communication device in response to the establishment of the communication link. Thereafter, establish a first correlating link between the unique identifier and the customer identifier. The processor is further configured to generate a profile of the customer at a storage unit in response to receiving the unique identifier, the profile identified by a unique anonymous ID of the customer. The processor is further configured to generate a passcode for the unique anonymous ID of the profile, wherein the passcode is utilized to unlock and/or decrypt the unique anonymous ID of the profile. The processor further establishes a second correlating link between the unique anonymous ID of the customer, the passcode and the unique identifier, the second correlating link is transmitted and stored at the communication device. The records of the customer pertaining to the customer data at the profile of the customer are received from at least one of, the customer, historic service providers and trusted members in response to a request by the customer, wherein the records of the customer are received at the profile based on the first and the second correlating links. The processor further extracts the customer data from the records and categorize in real time the customer data in at least one class of multiple classes, wherein each class defines at least one particular attribute of the customer. Thereafter, the processor receives via the communication transceiver, the credentials of the customer from the communication device along with the copy of the passcode and the unique anonymous ID and appends to the profile identified by the unique anonymous ID based on the first and the second correlating links in response to a consent by the customer in response to a future service provider request to access the customer data. Further the processor generates a secured link with the future service provider communication device to allow the future service provider to access the customer data categorized within the at least one class for a pre-determined time period based on one of, type of the future service provider and requirements from the future service provider.

In yet another aspect of the invention, a computer implemented method for management of access to customer data is provided. The method comprises the steps of: providing an installable customer interface module on a communication device operable by a processor. Further, receiving credentials of a customer via the customer interface module at the communication device of the customer. Further, establishing by a processor of an application server, a communication link with the communication device in response to installation of the customer interface module. The processor further, establishes a first correlating link between a unique identifier and a customer identifier received from the communication device in response to establishment of the communication link. Generating by the processor, a profile of the customer at a storage unit in response to receiving the unique identifier, the profile identified by a unique anonymous ID of the customer. Generating by the processor, a passcode for the unique anonymous ID of the profile. Establishing by the processor, a second correlating link between the unique anonymous ID of the customer, the passcode and the unique identifier, the second correlating link transmitted and stored at the communication device. Receiving records of the customer pertaining to the customer data at the profile of the customer from at least one of, the customer, one or more historic service providers and trusted members in response to a request by the customer, wherein the records of the customer are received at the profile based on the first and the second correlating links. Extracting by the processor, the customer data from the records and categorize in real time the customer data in at least one class of multiple classes, wherein each class defines at least one particular attribute of the customer. Receiving via the communication transceiver, the credentials of the customer from the communication device along with the copy of the passcode and append to the profile identified by the unique anonymous ID based on the first and the second correlating links in response to a consent by the customer in response to a future service provider request to access the customer data. Finally, generating by the processor, a secured link with the future service provider communication device to allow the future service provider to access the customer data categorized within the at least one class for a pre-determined time period based on one of, type of the future service provider and requirements from the future service provider.

Other features and aspects of this invention will be apparent from the following description and the accompanying drawings. The features and advantages described in this summary and in the following detailed description are not all-inclusive, and particularly, many additional features and advantages will be apparent to one of ordinary skill in the relevant art, in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

Reference will be made to embodiments of the invention, examples of which may be illustrated in the accompanying figures. These figures are intended to be illustrative, not limiting. The accompanying figures, which are incorporated in and constitute a part of the specification, are illustrative of one or more embodiments of the disclosed subject matter and together with the description explain various embodiments of the disclosed subject matter and are intended to be illustrative. Further, the accompanying figures have not necessarily been drawn to scale, and any values or dimensions in the accompanying figures are for illustration purposes only and may or may not represent actual or preferred values or dimensions. Although the invention is generally described in the context of these embodiments, it should be understood that it is not intended to limit the scope of the invention to these particular embodiments.

FIG. 1 is an environment for management of customer data, according to one or more embodiments of the present invention;

FIG. 2 is a block diagram of a system for management of access to records, according to one or more embodiments of the present invention;

FIG. 3 is an example of an interface that is generated once the customer interface module is installed on the communication device of the customer, according to one or more embodiments of the present invention;

FIG. 4 illustrates an exemplary embodiment of usage of correlating links to determine different parameters of the present invention, in accordance with one or more embodiments of the present invention;

FIG. 5 illustrates an example of a profile of the customer generated at a storage unit of the system of FIG. 2, according to one or more embodiments of the present invention;

FIG. 6 illustrates a working example of generating a secure channel to access customer data, according to one or more embodiments of the present invention;

FIG. 7 illustrates a flowchart of a computer implemented method for management of access to customer data, according to one or more embodiments of the present invention; and

FIG. 8 is a block diagram of computing device that may be used to implement the systems and methods described in this document, according to or more embodiments of the present invention.

### DETAILED DESCRIPTION OF THE INVENTION

Reference will now be made in detail to specific embodiments or features, examples of which are illustrated in the accompanying drawings. Wherever possible, corresponding or similar reference numbers will be used throughout the drawings to refer to the same or corresponding parts. References to various elements described herein, are made collectively or individually when there may be more than one element of the same type. However, such references are merely exemplary in nature. It may be noted that any reference to elements in the singular may also be construed to relate to the plural and vice-versa without limiting the scope of the invention to the exact number or type of such elements unless set forth explicitly in the appended claims. Moreover, relational terms such as first and second, and the like, may be used to distinguish one entity from the other, without necessarily implying any actual relationship or between such entities.

Various embodiments of the invention provide system and method for management of access to customer data. The present invention is configured to provide system and method for management of access to customer data by ensuring anonymity and privacy of customers are maintained. The present invention can be applied to fields such as, at least one of, but not limited to, medical, banking, government, information technology, etc.

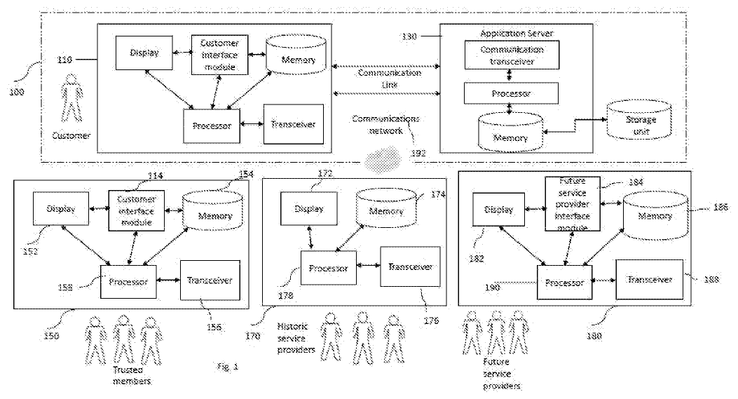

FIG. 1 illustrates an environment for management of customer data, according to one or more embodiments of the present invention. The environment includes a system 100, trusted member communication devices 150, historic service provider communication devices 170 and a future service provider communication device 180. The system 100, the trusted member communication devices 150, the historic service provider communication devices 170 and the future service provider communication device 180 communicate with each other over a communications network 192.

The communications network 192 can be one of, but not limited to, LAN, cable, WLAN, cellular, or satellite.

In accordance with an embodiment of the invention, the trusted member communication device 150 includes a display 152, a customer interface module 114, a memory 154, a transceiver 156 and a processor 158. The processor 158 controls the operation of the display 152, the memory 154 and the transceiver 156. The customer interface module 114 is also configured to display and facilitate the trusted member to input and/or view data.

Further, in accordance with an embodiment of the invention, the historic service provider communication device 170 includes a display 172, a memory 174, a transceiver 176 and a processor 178. The processor 178 controls the operation of the display 172, the memory 174 and the transceiver 176. In an alternate embodiment, the historic service provider interface module (not shown) may be required to be installed by the historic service provider. The historic service provider interface module is configured to display and facilitate the historic service provider to input and/or view data.

In accordance with an embodiment of the invention, the future service provider communication device 180 includes a display 182, a future service provider interface module 184, a memory 186, a transceiver 188 and a processor 190. The processor 190 controls the operation of the display 182, the future service provider interface module 184, the memory 186 and the transceiver 188. The future service provider interface module 184 is configured to display and facilitate the future service provider to input and/or view data. In an alternate embodiment, the future service provider can access the customer data via the future service provider communication device 180 as a guest without installing the future service provider interface module.

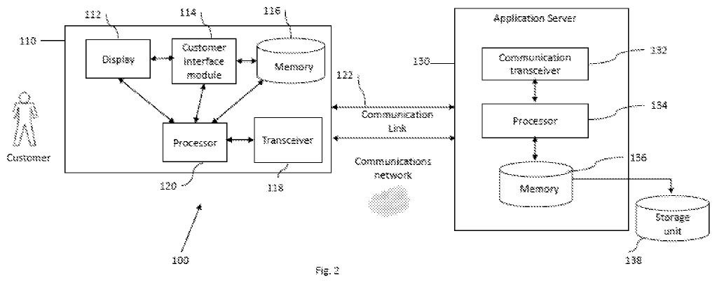

The FIG. 2 illustrates a block diagram of the system 100 for management of access to customer data, according to one or more embodiments of the present invention. The system 100, as disclosed herein, includes a customer communication device 110 and an application server 130. The customer communication device 110 will hereinafter be referred to as the communication device 110.

The communication device 110 includes a display 112, a customer interface module 114, a memory 116, a transceiver 118 and a processor 120. The processor 120 controls the operation of the display 112, the customer interface module 114, the memory 116 and the transceiver 118. The customer interface module 114 is required to be installed by the customer on the communication device 110. The customer interface module 110 is configured to display and facilitate the customer to input and/or view data.

In an embodiment, the communication device 110, the trusted member communication devices 150, the historic service provider communication devices 170 and the future service provider communication device 180 are one of, but not limited to, a mobile phone, a laptop, a desktop, PDA, tablet and a virtual storage medium such as, but not limited to, cloud.

The application server 130 includes a communication transceiver 132, a processor 134, a memory 136 and a storage unit 138 present within the application server 130 or located remotely outside the application server as shown in FIG. 2.

The communication device 110 communicates with the application server via the communications network 192.

In an embodiment, within the communication device 110, the display 112 is in communication with the customer interface module 114. The customer interface module 114 is in communication with the memory 116. The display 112, the customer interface module 114, the memory 116 and the transceiver 118 are in communication with the processor 120.

In an embodiment, within the application server 130, the communication transceiver 132 is in communication with the processor 134. The processor 134 is in communication with the memory 136. The memory 136 is in communication with the storage unit 138 which is located remotely from the application server 130 or located within the application server 130.

The processor 120 and the processor 134 explained hereinafter, are the processors that may be implemented as one or more microprocessors, microcomputers, microcontrollers, digital signal processors, central processing units, state machines, logic circuitries, and/or any devices that manipulate signals based on operational instructions. Among other capabilities, the processor is configured to fetch and execute computer-readable instructions stored in the memory.

The memory 116, 154, 174, 186 referred hereinafter, in general includes memory and any other storage means and/or units may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

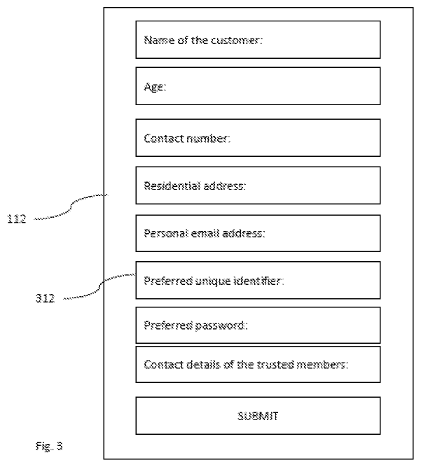

At the outset, the customer is required to register with the system 100 and create an account. For registration, the customer is required to install the customer interface module 114. FIG. 3 illustrates an example of an interface 310 that is generated on the display 112 of the communication device 110 once the customer interface module 114 is installed. The interface 310 displays a questionnaire required to be filled up by the customer. The questionnaire requires the customer to input credential details such as, but not limited to, name of the customer, age, personal email address, customer identifier such as, but not limited to, contact number, residential address, preferred unique identifier and password. Once the credential details are input by the customer on the interface 310, the processor 120 of the communication device 110 checks to verify if the details provided are in the right order. In case there are any errors, the same is indicated to the customer to rectify. Thereafter, a verification code is sent to either the customer's email address or the contact number of the customer. The customer is required to input the verification code at the communication device. Once this task is completed, the customer is said to be registered. The credentials of the customer which is received is stored in the memory 116 of the communication device 110.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

Further, while one or more operations have been described as being performed by or otherwise related to certain modules, devices or entities, the operations may be performed by or otherwise related to any module, device or entity. As such, any function or operation that has been described as being performed by a module could alternatively be performed by a different server, by the cloud computing platform, or a combination thereof.

In an embodiment, the credentials received at the communication device 110 is forwarded to other allied devices of the customer such as, but not limited to, credit card, smart card, hard drive, pen drive and cloud storage means, in response to the customer providing consent via the customer interface module 114 of the communication device 110.

In an alternate embodiment, in response to the customer providing consent on the communication device 110, the processor 120 of the communication device 110 can retrieve the credentials of the customer from other sources such as, social media such as, but not limited to, Facebook, Linkedin, etc. Further, the processor 120 can retrieve the credentials of the customer from other remote devices of the customer such as, apple watch, fit bit, etc.

The customer can be any user/organization intending to keep the customer data confidential. In an embodiment, the customer can be one of, but not limited to, a patient and a banker.

Once the customer interface module 114 is installed and the customer is registered, a communication link 122 is established between the communication device 110 and the application server 130.

In an embodiment, the communication link 122 is a communications channel that connects two or more devices over the communications network 192, herein mainly the communication device 110 and the application server 130, for the purpose of data transmission. The communication link 122 may be a dedicated physical link or a virtual circuit that uses one or more physical links or shares a physical link with other telecommunications links.

Pursuant to establishment of the communication link 122, the application server 130 receives a customer identifier from the communication device 110. The customer identifier can be, but not limited to, contact number of the customer. Thereafter, the unique identifier is received from the communication device 110 at the application server 130. Once the unique identifier is received, a first correlating link is established between the unique identifier and the communication device 110 via the customer identifier and stored at the storage unit 138. In an embodiment, the first correlating link can contain information of the customer identifier, herein the customer contact number of the communication device 110. For example, let us consider, the unique identifier is abc@xyz.com and the contact number, i.e. the customer identifier of the communication device 110 is '1234. In the present example, the first correlating link can contain information in the format such as, but not limited to, [Customer identifier-1234; Unique identifier-abc@xyz.com].

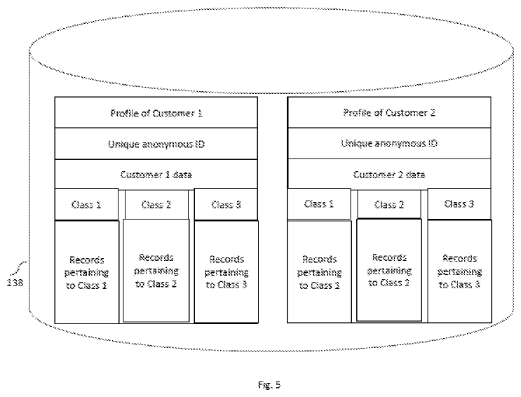

Once the first correlating link is established at the application server 130, a profile of the customer is generated at the storage unit 138 as shown in FIG. 5 and the location data of the profile is stored at the memory 136 of the application server 130. The profile is identified by a unique anonymous ID. In an embodiment, the unique anonymous ID can be, but not limited to, alphanumeric set of characters. Advantageously, if there is any hack initiated by third parties, the third parties will not be able to identify that the profile belongs to the customer due to the unique anonymous ID of the profile.

Further, a passcode for the unique anonymous ID of the profile is generated. The passcode is configured to unlock the unique anonymous ID of the profile. In an embodiment, the passcode can be one of, but not limited to, a numeric sequence.

The passcode that is generated is transmitted to the communication device 110 along with the unique anonymous ID. In an embodiment, the passcode is utilized to unlock the unique anonymous ID and the credentials received from the customer at the communication device 110. In an embodiment, the passcode that is received along with the unique anonymous ID at the communication device 110 are mirrored along with the credentials and the unique identifier of the customer to the trusted member communication devices 150 based on consent provided by the customer. In an embodiment, all the communication devices such as the communication device 110 and the trusted member communication devices 150 where the passcode, the credentials, the unique anonymous ID and the unique identifier are mirrored can also be used as an alternate customer identifier stored at the application server 130. In case the trusted members are not selected by the customer, the passcode, the credentials, the unique anonymous ID, the passcode and the unique identifier will not be transmitted to those communication devices. Advantageously, in case of pre-defined events such as, but not limited to, the customer losing the communication device and emergencies, the trusted members can initiate the access to customer data only if the customer has selected the pre-defined events at the time of registering or during the course of usage. Advantageously, during the occurrence of the pre-defined events, the access to customer data can continue without being terminated.

In an embodiment, the unique identifier can be an email address for example, abc@xyz.com.

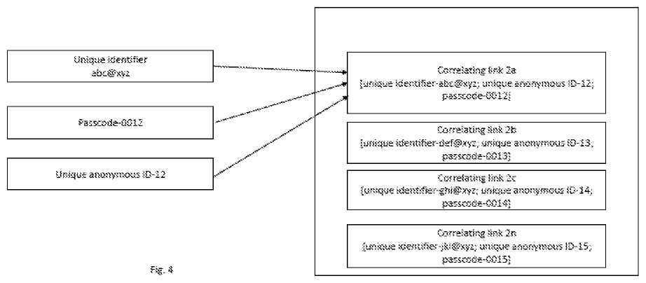

Once the passcode is generated, the processor 134 of the application server 130 establishes a second correlating link between the unique anonymous ID of the customer, the passcode and the unique identifier. In an embodiment, the second correlating link can include information of each of the unique anonymous ID, the unique identifier and the passcode. For example, the second correlating link can include information in the format such as, but not limited to, [unique identifier-abc@xyz.com; anonymous unique ID-12; passcode-0012] as shown in FIG. 4. The data of the second correlating link is encrypted, transmitted and stored in the communication device 110. Advantageously, this ensures that the privacy is maintained. The second correlating link is, configured to link the unique identifier, the unique anonymous ID and the passcode. Advantageously, the application server 130 ensures that the unique identifier is not linked to the profile of the customer generated at the storage unit, thereby ensuring the profile of the customer is anonymous bearing the unique anonymous ID.

In an embodiment, the customer can share the records of the customer data utilizing the unique identifier. For example, the customer can transmit the records that are available using the communication device 110 via the email address, i.e. the unique identifier. Further, the trusted members can also share the records pertaining to the customer data using the trusted member communication devices 150 utilizing the unique identifier of the customer. Further, the historic service providers can also share the records of the customer data via the historic service provider communication devices 170 via the unique identifier of the customer.

Once the records are received at the application server 130 via the unique identifier of the customer, the processor 134 of the application server 130 scans the characters of the unique identifier. At the outset, if the unique identifier is abc@xyz.com, the processor 134 recognizes the combination of the characters ‘abc’ utilizing at least one character recognition technique. Based on recognition of the characters of the unique identifier, the processor 134 compares the recognized unique identifier with the customer identifier of the first correlating link stored at the application server 130 to identify the identity of the communication device 110 of the customer. Further, the processor 134 based on the identity of the communication device 110, identifies the unique anonymous ID of the customer based on checking with the second correlating link stored at the communication device 110. In an embodiment, the processor 134 includes a key for the encrypted second correlating link. Before, the unique anonymous ID is determined, the key is utilized to decrypt the second correlating link at the communication device 110. Alternatively, the passcode of the second correlating link is used to unlock the unique anonymous ID to identify the same, thereby identifying the unique anonymous ID.

Further, in another example embodiment as shown in FIG. 4, the processor 134 determines the unique anonymous ID by comparing the unique identifier of the customer which is part of the first correlating link with the plurality of second correlating links 2a to 2n stored in the communication device 110 and the trusted member communication devices 150 to identify a match. The second correlating link as discussed above, includes the information of the unique anonymous ID, the unique identifier and the passcode. As shown in FIG. 4, the unique anonymous ID is 12, which is interlinked to the profile of the customer. Based on this determined unique anonymous ID, the records that are received are stored at the profile of the customer in real time.

In an embodiment, the trusted members are, but not limited to, family members of the customer. Further, the historic service providers include service providers who have provided service to the customer in the past.

In an embodiment, the customer may select on the communication device 110, an option of sending a request to the one or more of the trusted members and the historic service providers to transmit the records of the customer. In addition, the customer can also request the historic service providers to transmit the records of the trusted members as well by transmitting their respective unique identifiers. Advantageously for instance in the medical field, by requesting the records of the trusted members such as family members will facilitate in populating important future health developments of family members onto the profile of the customer, thereby understanding treatment of customer better.

Further, via the customer interface module 114 on the communication device 110, the customer can provide his/her personal email address so that via his/her personal email address, all the emails related to customer data can be auto-forwarded to the profile of the customer which is stored at the storage unit.

When the records are received at the storage unit 138 of the application server 130, the processor 134 of the application server 130 categorizes in real time the customer data of the records into multiple classes, wherein each class defines a particular attribute of the customer as shown in FIG. 5.

In an embodiment, the attribute can include characteristic of the customer. For example in the medical field, the attributes of the customer can include various medical conditions such as, but not limited to, heart, lungs, bones, nerves, stomach, liver, etc. Further, the multiple classes at the storage unit 138 can include cardiology, pulmonary, neurology, Gastroenterology and hepatology.

Therefore, when the records are received from the trusted members and historic service providers, the processor 134 of the application server 130 firstly scans through each record to identify the content. Based on the content, the processor 134 categorized the records in at least one class of the multiple classes at the storage unit 138. For example, if the processor 134 after scanning through record-1, identifies that the content of the record is related to heart condition of the customer, then the processor categorizes the record-1 at class 1 related to cardiology.

Further, if record-1 contains customer data related to two or more medical conditions such as, for example, heart and lungs, then the processor categorizes the record-1 in class 1 and class 2, respectively.

In an embodiment, the processor 134 utilizes the pre-defined keyword logic to identify whether the content in the records are related to a particular class. Each class of the multiple classes include pre-defined keywords related to the various standards of a particular field. For instance in the medical field, each class stored at the storage unit will include keywords related to the medical standards. Therefore, when any new record is received at the storage unit, the processor correlates the keywords stored in each class with the content of the record to identify under which class the record is required to be categorized. For example, once the record-1 which is received at the storage unit, the processor 134 compares in real time, the content of record-1 with keywords of class-1, class-2, class-3, etc. Once there is a match at least in part of the content of record-1 with the keywords at least in one of the classes, herein class-1, class-2, class-3, etc., then the processor 134 automatically categorizes the record-1 in at least one of these classes.

Once the records are categorized, the system 100 may allow manual intervention to verify the records categorized are relevant.

In an embodiment, if the processor 134 is not able to categorize the received record in a particular class, then the processor 134 may communicate with external data sources to check if there are any additional keywords that are required to be added into the class. For instance in the medical field, there are new conditions detected everyday. Corona virus for example includes symptoms of difficulty in breathing, which in-turn is related to lungs. Therefore, if the record-1 received includes content related to corona virus, and the processor 134 is not able to categorize the said record in any of the existing classes, then the processor 134 can communicate with external genuine data sources. The processor 134 will collate keywords related to corona virus form the external data sources and correlate with the content of the record-1. Once a match at least in part is identified by the processor 134, the record-1 may be categorized into class related to lungs (due to difficulty in breathing) or a new class may be created for the particular medical condition. Advantageously, the processor 134 populates the storage unit 138 with new keywords and classes, thereby ensuring that the storage unit 138 is updated with the current standards.

In an embodiment, the system 100 can allow the categorized records to be verified by manual intervention.

In an embodiment, the processor 134 scans through the records using character recognition techniques. The character recognition technique is one of, but not limited to, Convolution Neural Networks, Recurrent Neural Networks, Support Vector Machines and K-nearest Neighbors. Further, if confidence of the recognized character is below a threshold, the characters have to be further scanned using a modified seam carving inspired algorithm. It is to be understood that the character recognition techniques as mentioned above are well known in the art.

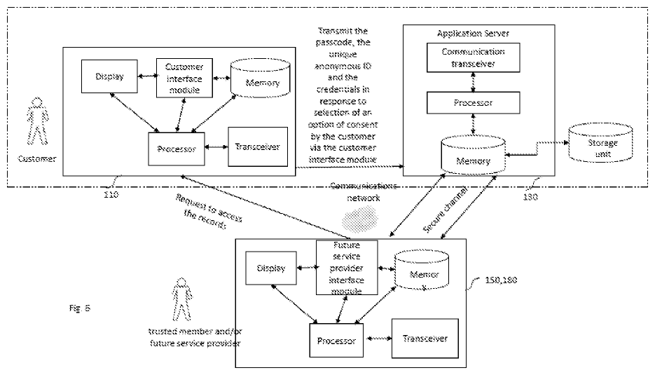

Once all the records are received at the storage unit 138 of the application server 130, the future service provider can request the customer to access the customer data stored at the storage unit 138 as shown in FIG. 6.

In an embodiment, the trusted member can also request the customer to access the customer data stored at the storage unit 138.

In the medical field, the future service providers can be medical professionals examining the customer at present and require the customer data as provided by historic medical professionals.

Firstly, to access the customer data, the future service provider can log-in as a guest or as a registered user with the application server 130. For registering, the future service provider is required to install the future service provider interface module 184. While installing the future service provider interface module 184, the future service provider is required to input details such as, but not limited to, name of the future service provider, contact details, qualification, address, proof of qualification and email address. In an embodiment, the qualification that is input by the future service provider will be authenticated by the processor of the application server. For example, let us consider that the future service provider's name is ‘Tom’ and qualified as a cardiologist. The future service provider may have to upload medical certification or provide a medical certification ID. The processor of the application server will communicate with external genuine medical data sources to confirm authenticity of the qualification in real time. Advantageously, only authenticated future service provider will be allowed to register. Once registered, a future service provider profile is created at the application server and a future service provider profile ID is generated for the same. Let us consider, that the profile ID is Tom.

In an alternate embodiment, the authentication of the future service provider can be performed manually.

As shown in FIG. 6, from the future service provider communication device 180, a request is sent to the communication device 110 of the customer to access the customer data, if not pre-approved by the customer.

In an alternate embodiment, the customer can pre-approve the access to the future service provider utilizing a temporary randomly generated access code via the customer interface module 114.

The request by the future service provider can contain information such as, but not limited to, name of the future service provider, reason for the request and the profile ID of the future service provider.

In an embodiment, the name of the future service provider can be the name of an individual or a name of an organization. For example, in the medical field, let us consider the name of the medical professional is ‘Tom’.

In an embodiment, the reason for request may be to access the customer data related to the particular attribute. For example, let us consider ‘Tom’ the cardiologist needs to access the customer data of customer X related to heart.

In response to the request by the future service provider, the credentials of the customer are received from the communication device 110 along with the passcode and the unique anonymous ID and are appended to the profile identified by the unique anonymous ID based on the first and the second correlating links. For example, in response to the request by the future service provider or a pre-approved access provided by the customer to the future service provider, the communication device 110 of the customer is identified by the processor 134 based on the first correlating link. Thereafter, the processor 134 will identify the unique anonymous ID by matching the unique identifier of the customer with the second correlating link from a plurality of second correlating links stored at the communication device 110. In the present example as shown in FIG. 4, the processor 134 identifies the communication device 110 of the customer by comparing the unique identifier that is received at the application server 130 with the first correlating link. Thereafter, the processor 134 compares the unique identifier abc@xyz.com with the plurality of correlating links 2a to 2n at the communication device 110 to identify a match of the second correlating link including the same unique identifier, thereby identifying the corresponding unique anonymous ID-12. Thereafter, the credentials of the customer are received at the application server 130 along with the copy of the passcode-0012 and the unique anonymous ID-12, based on identification of the unique anonymous ID of the customer. In another example embodiment, the unique anonymous ID is identified based on the determined communication device 110 of the customer based on the first correlating link at the application server 130 and thereafter, identifying the unique anonymous ID of the customer based on the second correlating stored at the communication device 110.

In an alternate embodiment, the processor 134 can instruct the processor 120 of the communication device 110 to perform the operation of matching with the second correlating link to determine the unique anonymous ID of the customer at the communication device 110. Thereafter, the processor 134 can receive information of unique anonymous ID of the customer from the processor 120 of the communication device 110 in real time.

Once the credentials are received at the application server 130, they are appended to the profile of the customer by unlocking the unique anonymous ID with the passcode. Thereafter, the processor 134 generates a secured link with the future service provider communication device 180 to allow in accessing the records categorized within at least one class of the multiple classes for a pre-determined time period based on one of, type of the future service provider and the request by the future service provider. For example, in the medical field, if the processor 134 of the application server 130 identifies that the future service provider is a cardiologist, customer data related to heart is retrieved from the class pertaining to cardiology. Thereafter, the processor 134 may also check if there is any note provided by the customer which may be transmitted along with the passcode from the communication device 110 to the application server 130. Let us consider, the customer has provided a note that only a certain part of the customer data related to heart is required to be allowed to the future service provider to access, then the processor 134 only allows the future service provider to access that portion of the data. The rest of the data is masked by the processor 134 using masking logics. For example, if the customer has provided a note that data related to only heart for the year 2020 is required to be provided access to the future service provider, then the processor scans through the customer data related to heart and only allows access to the data related to heart for the year of 2020 in real time.

In an embodiment, the processor 134 of the application server 130 only allows the future service provider to access the customer data for a pre-determined time period using blockchain technology. The pre-determined time period can be one of, selected by the customer and pre-defined by the processor. In a preferred embodiment, since the blockchain technology is used herein, the pre-defined time period cannot be altered, whatsoever.

Once the pre-determined time period expires, the processor 134 of the application server 130 terminates the secured link to the customer data. Thereafter the future service provider will not be able to access the customer data. To ensure the customer data is kept confidential, the processor 134 of the application server 130 ensures that the future service provider is not allowed to save or download the customer data.

Further, once the pre-determined time period expires, the credentials appended to the profile of the customer at the storage unit 138 is also automatically erased. Advantageously, by deleting the credentials of the customer at the storage unit 138, the customer data will be kept anonymous and confidential irrespective of any third party hacking the system, thereby ensuring secured access to customer data.

In an alternate embodiment, the processor 134 generates a secured link with the trusted member communication device 150 to allow in accessing the records categorized within at least one class of the multiple classes for a pre-determined time period based on request by the trusted member or pre-approved access provided by the customer.

Based on the above examples and embodiments as illustrated above, the customer has complete control over the customer data. Advantageously, confidentiality of the customer data is given utmost importance in the present invention.

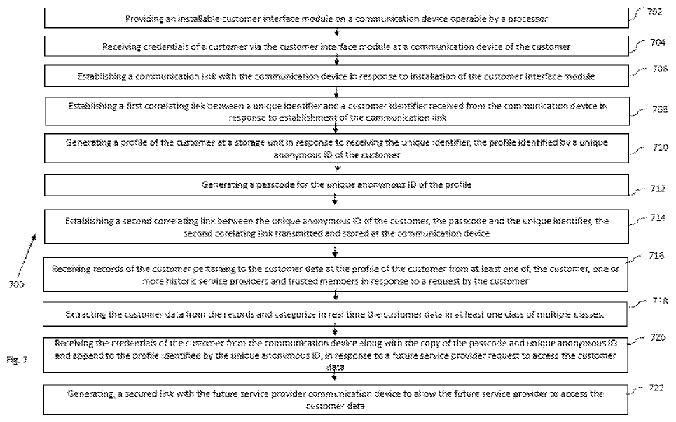

FIG. 7 shows a flowchart of a computer implemented method for management of access to customer data in accordance with an embodiment of the invention. For the purpose of description, the method is described with the embodiment as illustrated in FIG. 1 to FIG. 6. The method comprises the steps as indicated below:

At step 702, providing an installable customer interface module on a communication device operable by a processor.

At step 704, receiving credentials of a customer via the customer interface module at a communication device of the customer.

At step 706, establishing by a processor of an application server, a communication link with the communication device in response to installation of the customer interface module.

At step 708, establishing by the processor, a first correlating link between a unique identifier and a customer identifier received from the communication device in response to establishment of the communication link.

At step 710, generating by the processor, a profile of the customer at a storage unit in response to receiving the unique identifier, the profile identified by a unique anonymous ID of the customer.

At step 712, generating by the processor, a passcode for the unique anonymous ID of the profile.

At step 714, establishing by the processor, a second correlating link between the unique anonymous ID of the customer, the passcode and the unique identifier, the second correlating link transmitted and stored at the communication device.

At step 716, receiving records of the customer pertaining to the customer data at the profile of the customer from at least one of, the customer, one or more historic service providers and trusted members in response to a request by the customer, wherein the records of the customer are received at the profile based on the first and the second correlating links.

At step 718, extracting by the processor, the customer data from the records and categorize in real time the customer data in at least one class of multiple classes, wherein each class defines at least one particular attribute of the customer.

At step 720, receiving via the communication transceiver, the credentials of the customer from the communication device along with the copy of the passcode and append to the profile identified by the unique anonymous ID based on the first and the second correlating links in response to a consent by the customer in response to a future service provider request to access the customer data.

At step 722, generating by the processor, a secured link with the future service provider communication device to allow the future service provider to access the customer data categorized within the at least one class for a pre-determined time period based on one of, type of the future service provider and requirements from the future service provider.

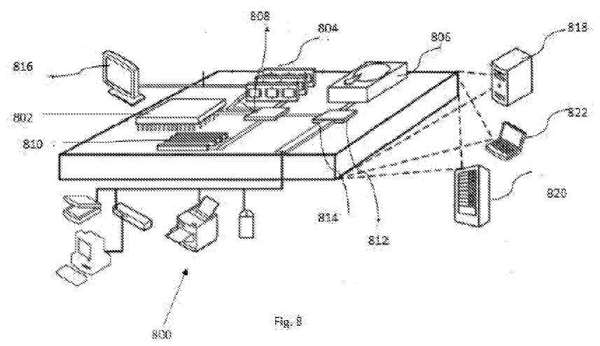

FIG. 8 is a block diagram of computing device 800 that may be used to implement the systems and methods described in this document, as a server or plurality of servers. Computing device is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations described and/or claimed in this document.

Computing device includes a processor 802, memory 804, a storage device 806, a high-speed interface 808 connecting to the memory 804 and high-speed expansion ports 810, and a low speed interface 812 connecting to low speed bus 814 and storage device 806. Each of the components 802, 804, 806, 808, 810, 812 and 814, are interconnected using various busses, and may be mounted on a common motherboard or in other manners as appropriate. The processor 802 can process instructions for execution within the computing device, including instructions stored in the memory or on the storage device to display graphical information for a GUI on an external input/output device, such as display 816 coupled to high speed interface. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 804 stores information within the computing device. In one implementation, the memory 804 is a computer-readable medium. In one implementation, the memory is a volatile memory unit or units. In another implementation, the memory is a non-volatile memory unit or units.

The storage device 806 is capable of providing mass storage for the computing device. In one implementation, the storage device 806 is a computer-readable medium. In various different implementations, the storage device 806 may be a floppy disk device, a hard disk device, an optical disk device, or a tape device, a flash memory or other similar solid-state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine readable medium, such as the memory, the storage device, memory on processor, or a propagated signal.

The high-speed controller manages bandwidth-intensive operations for the computing device, while the low speed controller manages lower bandwidth-intensive operations. Such allocation of duties is exemplary only. In one implementation, the high-speed controller is coupled to memory, display (e.g., through a graphics processor or accelerator), and to high-speed expansion ports, which may accept various expansion cards (not shown). In the implementation, low-speed controller is coupled to storage device and low-speed expansion port. The low-speed expansion port, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device may be implemented in a number of different forms, as shown in the figure. For example, it may be implemented as a standard server 818, or multiple times in a group of such servers. It may also be implemented as part of a rack server system 820. In addition, it may be implemented in a personal computer such as a laptop computer 822. Alternatively, components from computing device may be combined with other components in a mobile device (not shown), such as device. Each of such devices may contain one or more of computing device, and an entire system may be made up of multiple computing devices 800 communicating with each other.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other categories of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

Embodiments may be implemented, at least in part, in hardware or software or in any combination thereof. Hardware may include, for example, analog, digital or mixed-signal circuitry, including discrete components, integrated circuits (ICs), or application-specific ICs (ASICs). Embodiments may also be implemented, in whole or in part, in software or firmware, which may cooperate with hardware. Processors for executing instructions may retrieve instructions from a data storage medium, such as EPROM, EEPROM, NVRAM, ROM, RAM, a CD-ROM, a HDD, and the like. Computer program products may include storage media that contain program instructions for implementing embodiments described herein.

While aspects of the present invention have been particularly shown and described with reference to the embodiments above, it will be understood by those skilled in the art that various additional embodiments may be contemplated by the modification of the disclosed machines, systems and methods without departing from the scope of what is disclosed. Such embodiments should be understood to fall within the scope of the present invention as determined based upon the claims and any equivalents thereof.

1. A system for management of access to customer data, the system comprising:
a communication device having an installable customer interface module operable on a processor, configured to receive credentials of a customer;
an application server including a communication transceiver, one or more processors coupled to a memory having instructions, the processor configured to:
establish a communication link with the communication device in response to installation of the customer interface module by the customer;
receive a unique identifier and a customer identifier of the customer from the communication device in response to the establishment of the communication link;
establish a first correlating link between the unique identifier and the customer identifier;
generate a profile of the customer at a storage unit in response to receiving the unique identifier, the profile identified by a unique anonymous ID of the customer;
generate a passcode for the unique anonymous ID of the profile, wherein the passcode utilized to unlock the unique anonymous ID of the profile;
establish a second correlating link between the unique anonymous ID of the customer, the passcode and the unique identifier, the second correlating link is transmitted and stored at the communication device;
receive records of the customer pertaining to the customer data at the profile of the customer from at least one of, the customer, historic service providers and trusted members in response to a request by the customer, wherein the records of the customer are received at the profile based on the first and the second correlating links;
extract the customer data from the records and categorize in real time the customer data in at least one class of multiple classes, wherein each class defines at least one particular attribute of the customer;
receive via the communication transceiver, the credentials of the customer from the communication device along with the copy of the passcode and the unique anonymous ID and append to the profile identified by the unique anonymous ID based on the first and the second correlating links in response to a consent by the customer in response to a future service provider request to access the customer data; and
generate a secured link with the future service provider communication device to allow the future service provider to access the customer data categorized within the at least one class for a pre-determined time period based on one of, type of the future service provider and requirements from the future service provider.

2. The system as claimed in claim 1, wherein the credentials of the customer include at least one of, name of the customer, age of the customer, residential address, personal email address, contact details of the trusted members, preferred unique identifier and preferred password received from at least one of, the customer via the customer interface module and external customer data sources in response to the customer granting consent.

3. The system as claimed in claim 2, wherein the contact details of the trusted members is at least one of, username, email address and contact number.

4. The system as claimed in claim 1, wherein the credentials received of the customer are mirrored along with the passcode and the unique anonymous ID to one or more communication devices belonging to the trusted members of the customer in response to the customer's consent.

5. The system as claimed in claim 1, wherein a selected portion of the customer data received from the one or more historic service providers, the customer and the trusted members are allowed to be accessed by the future service provider based on customer's request via the customer interface module.

6. The system as claimed in claim 1, wherein the secured link between the future service provider communication device and the application server is terminated once the pre-determined time period expires.

7. The system as claimed in claim 6, wherein in response to termination of the secured link between the future service provider communication device and the application server, the appended credentials of the customer to the profile at the application server is automatically erased.

8. A computer implemented method for management of access to customer data, the method comprises the steps of:
providing an installable customer interface module on a communication device operable by a processor;
receiving credentials of a customer via the customer interface module at the communication device of the customer;
establishing by a processor of an application server, a communication link with the communication device in response to installation of the customer interface module;
establishing by the processor, a first correlating link between a unique identifier and a customer identifier received from the communication device in response to establishment of the communication link;
generating by the processor, a profile of the customer at a storage unit in response to receiving the unique identifier, the profile identified by a unique anonymous ID of the customer;
generating by the processor, a passcode for the unique anonymous ID of the profile;
establishing by the processor, a second correlating link between the unique anonymous ID of the customer, the passcode and the unique identifier, the second correlating link transmitted and stored at the communication device;
receiving records of the customer pertaining to the customer data at the profile of the customer from at least one of, the customer, one or more historic service providers and trusted members in response to a request by the customer, wherein the records of the customer are received at the profile based on the first and the second correlating links;
extracting by the processor, the customer data from the records and categorize in real time the customer data in at least one class of multiple classes, wherein each class defines at least one particular attribute of the customer;
receiving via the communication transceiver, the credentials of the customer from the communication device along with the copy of the passcode and the unique anonymous ID and append to the profile identified by the unique anonymous ID based on the first and the second correlating links in response to a consent by the customer in response to a future service provider request to access the customer data; and
generating by the processor, a secured link with the future service provider communication device to allow the future service provider to access the customer data categorized within the at least one class for a pre-determined time period based on one of, type of the future service provider and requirements from the future service provider.
